(19) United States
(12) Patent Application Publication
(10) Pub. No.: US 2026/0217463 A1
(43) Pub. Date: Jul. 30, 2026

(54) METHOD AND SYSTEM FOR DYNAMICALLY ALLOCATING RESOURCES IN AN AUTOMATED STORAGE AND RETRIEVAL SYSTEM

(71) Applicant: Ocado Innovation Limited, Hatfield (GB)

(72) Inventors: Nicole GAVRIL, Hatfield (GB); Jieren KE, Hatfield (GB); George BELOKAPOV, Hatfield (GB); Michael ALEXOPOULOS, Hatfield (GB); James CARRINGTON, Hatfield (GB); Gareth SIRET, Hatfield (GB); David CATTLE, Hatfield (GB); Callum KILBY, Hatfield (GB); Qingyu FENG, Hatfield (GB); Philippe MICHAUD-JACOBS, Hatfield (GB)

(21) Appl. No.: 19/574,487

(22) Filed: Mar. 23, 2026

Related U.S. Application Data
(63) Continuation of application No. PCT/EP2024/077137, filed on Sep. 26, 2024.

(30) Foreign Application Priority Data
Sep. 28, 2023 (GB) 2314927.1

(51) Int. Cl. B65G 1/137; B65G 1/04; G06Q 10/087

(52) U.S. Cl. CPC B65G 1/1373; B65G 1/0464; G06Q 10/08743

(57) ABSTRACT

Computer-implemented methods control an automated storage and retrieval system having a grid of tracks and a plurality of load handling devices. An example method includes: controlling each load handling devices to perform either a picking task or an outbound task, wherein a picking task comprises moving containers to and/or from a picking station to fill containers, each filled container including at least one predetermined item, where an outbound task includes moving a filled container to an exit area for the filled containers; determining a target number of filled containers; determining a real-time number of filled containers; and apportioning the plurality of load-handling devices between picking tasks and outbound tasks based on a difference between the target number of filled containers and the real-time number of the filled containers. This means the container throughout of the system is maximised in an efficient way. Related systems are described.

### RELATED APPLICATIONS

This application is a continuation of International Patent Application No. PCT/EP2024/077137, filed 26 Sep. 2024 and entitled “Method and System for Dynamically Allocating Resources in an Automated Storage and Retrieval System,” which claims priority to UK Patent Application No. GB2314927.1, filed 28 Sep. 2023 and entitled “Method and System for Dynamically Allocating Resources in an Automated Storage and Retrieval System”; the entire contents of all of which applications are incorporated herein by reference.

### TECHNICAL FIELD

The present invention relates to a method and system for dynamically allocating resources in an automated storage and retrieval system, ASRS. Resources are allocated efficiently to maximise ASRS throughput.

### BACKGROUND

Some commercial and industrial activities require systems that enable the storage and retrieval of a large number of different items/products. WO2015/185628A describes an ASRS in which stacks of containers are arranged within a grid storage structure. The containers are accessed from above by load-handling devices operative on rails or tracks located on the top of a grid storage structure. The load-handling devices (or “bots”) are further described in International Patent Application Publication No. WO2015/019055A1.

International Patent Application Publication No. WO2015/185628A2 also describes how the load-handling devices are controlled to move containers into, within, and out of the grid storage structure. The load-handling devices move the containers to perform a number of tasks to enable an order or customer order to be fulfilled. Two of the tasks are conceptually shown in FIG. 1. The ASRS 5 is connected to picking stations 50 (also known as workstations) and outbound areas 60. Only two of each are shown for simplicity, but it will be appreciated that an ASRS may connect with significantly more picking stations and outbound areas. The ASRS holds both storage and order (or customer order) containers. Each storage container typically holds a number of the same item/product (e.g. one storage container may store soft drinks, and another storage container may store bread; whilst grocery items are used as an example, any product type in principle may be used). Order containers contain a number of different items/products as per a customer order. As shown by FIG. 1, a picking task involves moving both the storage and order containers to and from picking stations to allow an item from a storage container to be placed in an order container. This process is repeated until an order container has been filled, at which point the order container is moved to the outbound area 60 as part of an outbound task. The outbound area is an exit area of the ASRS for the order container so that it can be delivered to the customer.

Minimising the number of load-handling devices whilst maximising ASRS throughput (i.e. number of completed/filled order containers) requires apportioning of the load-handling devices between the picking and outbound tasks. A fixed apportion can be derived using simulation. Such a simulation takes into account a number of factors, including the number and/or breakdown of customer orders, the size of the ASRS, the number of pick stations or outbound areas currently active and available. However, such simulations are computationally expensive and time consuming since a sweep of all values of each factor is required. Further, a fixed apportion cannot react to changing operational conditions in the ASRS, such as the speed at which order containers are filled at the pick stations, or an unexpected spike in customer orders.

A way of apportioning the load-handling devices is needed.

### SUMMARY

In a first aspect, there is a computer-implemented method for controlling a system, the system comprising:
a first set of tracks extending in a first direction and a second set of tracks extending in a second direction which is transverse to the first direction, wherein the first and second sets of tracks are in a substantially horizontal plane to form a grid comprising a plurality of grid spaces to form a plurality of vertical storage locations beneath the grid for containers to be guided by uprights in a vertical direction through the plurality of grid spaces;
a plurality of load handling devices, wherein each load-handling device is configured to move along the first and/or second sets of tracks, and lift a container from beneath the grid and/or lower a container beneath the grid, the method comprising:
controlling each of the plurality of load handling devices to perform either a picking task or an outbound task, wherein a picking task comprises moving containers to and/or from a picking station to fill containers, each filled container comprising at least one predetermined item, wherein an outbound task comprises moving a filled container to an exit area of the system for the filled containers;
determining a target number of filled containers;
determining a real-time number of filled containers; and
apportioning the plurality of load-handling devices between picking tasks and outbound tasks based on a difference between the target number of filled containers and the real-time number of the filled containers. This means the container throughout of the system is maximised in an efficient way.

Upon the real-time number of filled containers being greater than the target number of filled containers, the number of load-handling devices performing an outbound task may be increased. This means the load-handling devices are allocated to appropriate tasks to maximise throughput.

The increase in the number of load-handling devices performing an outbound task may be directly proportional to the difference between the real-time number of filled containers and the target number of filled containers. This reduces the calculation burden when determining the apportionment of the load-handling devices.

The increase in the number of load-handling devices performing an outbound task may be a function of the difference between the real-time number of filled containers and the target number of filled containers. The function may be derived using a proportional-integral-derivate, PID, controller. This increases the accuracy when determining the apportionment of the load-handling devices.

Upon the real-time number of filled containers being less than the target number of filled containers, the number of load-handling devices performing a picking task may be increased. This means the load-handling devices are allocated to appropriate tasks to maximise throughput.

The increase in the number of load-handling devices performing a picking task may be directly proportional to the difference between the real-time number of filled containers and the target number of filled containers. This reduces the calculation burden when determining the apportionment of the load-handling devices.

The increase in the number of load-handling devices performing a picking task is a function of the difference between the real-time number of filled containers and the target number of filled containers. The function may be derived using a proportional-integral-derivate, PID, controller. This increases the accuracy when determining the apportionment of the load-handling devices.

Each pick station may comprise an area to which and/or from which a load-handling device can move containers such that an item can be transferred from a storage container to an order container. Each pick station may comprise a robotic arm to transfer an item from a storage container to an order container. The robotic arm may be disposed above the containers and adapted to be operable on or above the first and/or second sets of tracks. This means an order or customer order can be fulfilled automatically.

Each exit area may comprise an area to which a load-handling device can move a filled container and/or from which a load-handling device can move an empty container. This means containers with a customer order (e.g. a filled container) can exit the system, or empty containers can be returned to the system.

The real-time number of filled containers may be observed periodically to define a rate. The target number of filled containers may be a target rate of filled containers. This means the container throughput of the system is continuously optimised.

A number of load-handling devices that is apportioned between picking and outbound tasks may be fixed. The number of load handling devices performing a picking task may be constrained by respective minimum and maximum limits, and the number of load handling devices performing an outbound task may be constrained by respective minimum and maximum limits. The method may further comprise requesting additional load handling devices to ensure that at least one of respective minimum limit of either the picking tasks or outbound tasks, is met. Any surplus load-handling devices beyond the respective maximum limit of the number of load-handling devices performing one of a picking task or an outbound task may be assigned to the other of the picking task or outbound task up to a respective maximum limit. Any surplus load-handling devices beyond the respective maximum limits of the number of load-handling devices performing a picking task and an outbound task may be released from performing either a picking task or an outbound task. This means the number of load-handling devices is currently optimised to account for current system operating conditions. Put another way, each of the load-handling devices can be allocated/assigned in a way that maximises system efficiency.

The load-handling devices may be controlled to move containers such that a given container arrives just-in-time for respective picking and/or outbound tasks to fulfil a respective customer order whilst using as few as load-handling device movements as possible. This further maximises the container throughput of the system by reducing the overall time taken to fulfil an order or customer order.

The method may be performed periodically to apportion the plurality of load-handling devices between picking tasks and outbound tasks every x minutes. This means the rate at which the container throughput of the system is optimised, can be customised.

A number of the plurality of load-handling devices used in the system, and/or a number of grid spaces, and/or a number of picking stations, and/or outbound areas, may scale with a number of customer orders or orders to be fulfilled over a period of time. This means the above methods can be used in any system (e.g. ASRS) configuration.

The system may comprises a plurality of picking stations to which and/or from which a load-handling device can move containers such that an item can be transferred from a storage container to an order container, wherein for picking tasks, the method may further comprise determining a number of under-capacity picking stations and a number of over-capacity pick stations, and apportioning the load-handling devices between moving containers to and from the picking stations based on the number of under-capacity picking stations and the number of over-capacity pick stations. The method may further comprise upon the number of under-capacity picking stations being greater than the number of over-capacity picking stations, increasing the number of load-handling devices to move containers to the underactive picking stations to balance the number of under-capacity picking stations and the number of over-capacity picking stations. The method may further comprise upon the number of under-capacity picking stations being less than the number of over-capacity picking stations, increasing the number of load-handling devices to move containers from the over-capacity picking stations to balance the number of under-capacity picking stations and the number of over-capacity picking stations. This further improves the efficiency of the ASRS.

The system may comprises a plurality of picking stations to which and/or from which a load-handling device can move containers such that an item can be transferred from a storage container to an order container, wherein for picking tasks, the method may further comprise determining a rate at which containers are moved to the picking stations and a rate at which containers are moved from the picking stations, and apportioning the load-handling devices between moving containers to and from the picking stations based on the rate at which containers are moved to the picking stations and the rate at which containers are moved from the picking stations. The method may further comprise upon the rate at which containers are moved to the picking stations being greater than the rate at which containers are moved from the picking stations, increasing the number of load-handling devices to move containers from the picking stations to balance the rate at which containers are moved to the picking stations and the rate at which containers are moved from the picking stations. The method may further comprise upon the rate at which containers are moved to the picking stations being less than the rate at which containers are moved from the picking stations, increasing the number of load-handling devices to move containers to the picking stations to balance the rate at which containers are moved to the picking stations and the rate at which containers are moved from the picking stations. This further improves the efficiency of the ASRS.

The system may comprises a plurality of exit areas to which a load-handling device can move a filled container and/or from which a load-handling device can move an empty container, wherein for outbound tasks, the method may further comprise, determining a number of under-capacity exit areas and a number of over-capacity exit areas, and apportioning the load-handling devices between moving filled containers and empty containers based on the number of under-capacity exit areas and the number of over-capacity exit areas. The method may further include upon the number of under-capacity exit areas being greater than the number of over-capacity exit areas, increasing the number of load-handling devices to move filled containers to the under-capacity exit areas to balance the number of under-capacity exit areas and the number of over-capacity exit areas. The method further may comprise upon the number of under-capacity exit areas being less than the number of over-capacity exit areas, increasing the number of load-handling devices to move empty containers from the over-capacity exit areas to balance the number of under-capacity exit areas and the number of over-capacity exit areas. This further improves the efficiency of the ASRS.

The system may comprise a plurality of exit areas to which a load-handling device can move a filled container and/or from which a load-handling device can move an empty container, wherein for outbound tasks, the method may further comprise determining a rate at which filled containers are moved to the exit areas and a rate at which empty containers are moved from the exit areas, and apportioning the load-handling devices between moving filled containers and empty containers based on the rate at which filled containers are moved to the exit areas and the rate at which empty containers are moved from the exit areas. The method may further comprise upon the rate at which filled containers are moved to the exit areas being greater than the rate at which empty containers are moved from the exit areas, increasing the number of load-handling devices to move empty containers from the exit areas to balance the rate at which filled containers are moved to the exit areas and the rate at which empty containers are moved from the exit area. The method may further comprise upon the rate at which filled containers are moved to the exit areas being less than the rate at which empty containers are moved from the exit areas, increasing the number of load-handling devices to move filled containers to the exit areas to balance the rate at which filled containers are moved to the exit areas and the rate at which empty containers are moved from the exit area. This further improves the efficiency of the ASRS.

In a second aspect, there is a computer program comprising instructions which, when the program is executed by a computer, cause the computer to carry out the method of the first aspect.

In a third aspect, there is a data processing system comprising means for carrying out the method of any of the first aspect.

In a fourth aspect, there is a system comprising:
a first set of tracks extending in a first direction and a second set of tracks extending in a second direction which is transverse to the first direction, wherein the first and second sets of tracks are in a substantially horizontal plane to form a grid comprising a plurality of grid spaces to form a plurality of vertical storage locations beneath the grid for containers to be guided by uprights in a vertical direction through the plurality of grid spaces;
a plurality of load handling devices, wherein each load-handling device is configured to move along the first and/or second sets of tracks, and lift a container from beneath the grid and/or lower a container beneath the grid;
at least one picking station;
at least one exit area; and
a controller configured to carry out the method of the first aspect.

### BRIEF DESCRIPTION OF DRAWINGS

The present invention is described with reference to one or more exemplary embodiments as depicted in the accompanying drawings, wherein:

FIG. 1 is a conceptual representation of how the ASRS moves containers to carry out picking and outbound tasks;

FIG. 2 shows a storage structure and containers;

FIG. 3 shows track on top of the storage structure illustrated in FIG. 2;

FIG. 4 shows load-handling devices on top of the storage structure illustrated in FIG. 2;

FIG. 5 shows a single load-handling device with container-lifting means in a lowered configuration;

FIGS. 6A and 6B show cutaway views of a single load-handling device with container-lifting means in a raised and a lowered configuration;

FIG. 7 shows a method for dynamically allocating load-handling devices according to the invention;

FIG. 8 shows a system for carrying out the method of FIG. 7 according to the invention;

FIG. 9 shows a conceptual representation of the application of the method of FIG. 7 according to the invention;

FIGS. 10A and 10B show control systems according to the invention;

FIG. 11 shows a method for limiting/capping the load-handling devices allocated to respective tasks according to the invention;

FIGS. 12 to 14 show conceptual representations of the application of the method of FIG. 11 according to the invention; and

FIG. 15 shows a further method that can be applied in addition or as an alternative to the above methods of FIGS. 7 and 11.

### DETAILED DESCRIPTION

### ASRS

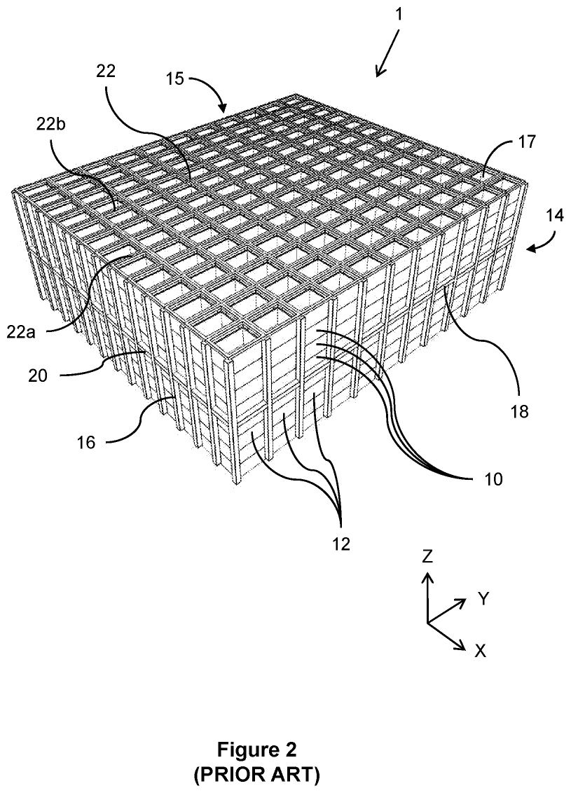

An ASRS is illustrated schematically in FIGS. 2 to 4 of the accompanying drawings.

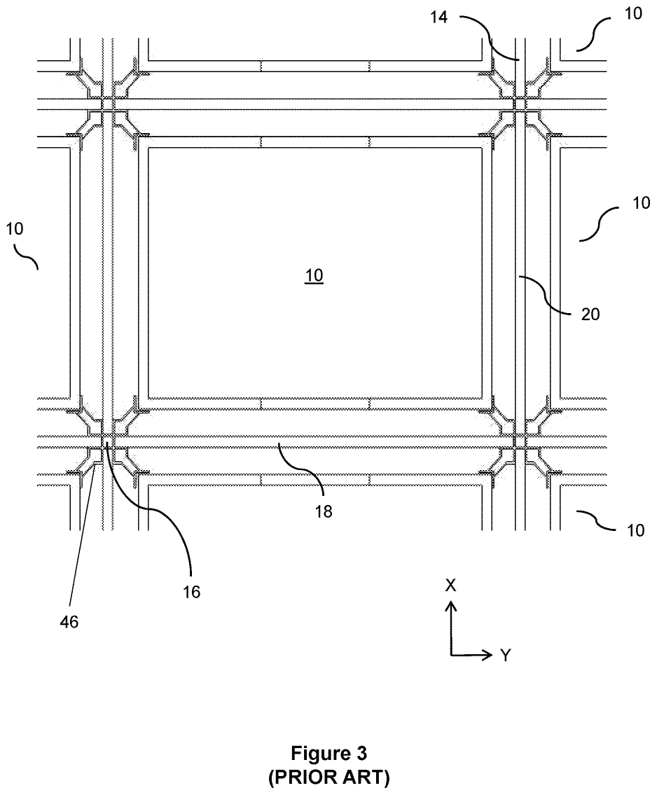

As shown in FIGS. 2 and 3, stackable containers 10, also known as “bins”, are stacked on top of one another to form stacks 12. The stacks 12 are arranged in a grid framework structure 14, e.g. in a warehousing or manufacturing environment. The grid framework structure 14 is made up of a plurality of storage columns or grid columns. Each grid in the grid framework structure has at least one grid column to store a stack of containers. FIG. 2 is a schematic perspective view of the grid framework structure 14, and FIG. 3 is a schematic top-down view showing a stack 12 of bins 10 arranged within the framework structure 14. Each bin 10 typically holds a plurality of products/items (not shown). The products/items within a bin 10 may be identical or different product types depending on the application.

The grid framework structure 14 comprises a plurality of upright members 16 that support horizontal members 18, 20. A first set of parallel horizontal grid members 18 is arranged perpendicularly to a second set of parallel horizontal members 20 in a grid pattern to form a horizontal grid structure 15 supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10 and guides the vertical movement of the bins 10.

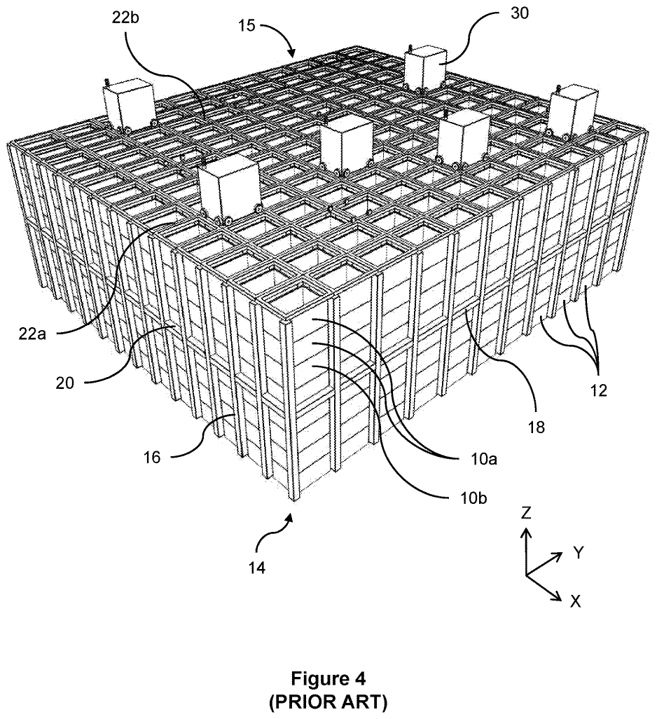

The top level of the grid framework structure 14 comprises a grid or grid structure 15, including rails 22 arranged in a grid pattern across the top of the stacks 12. Referring to FIG. 4, the rails or tracks 22 guide a plurality of load-handling devices 30. A first set 22a of parallel rails 22 guide movement of the robotic load-handling devices 30 in a first direction (e.g. an X-direction) across the top of the grid framework structure 14. A second set 22b of parallel rails 22, arranged perpendicular to the first set 22a, guide movement of the load-handling devices 30 in a second direction (e.g. a Y-direction), perpendicular to the first direction. In this way, the rails 22 allow the robotic load-handling devices 30 to move laterally in two dimensions in the horizontal X-Y plane. A load-handling device 30 can be moved into position above any of the stacks 12.

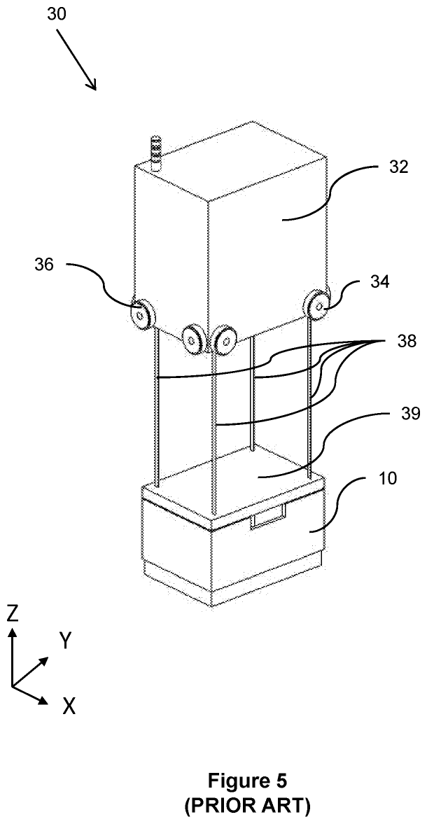

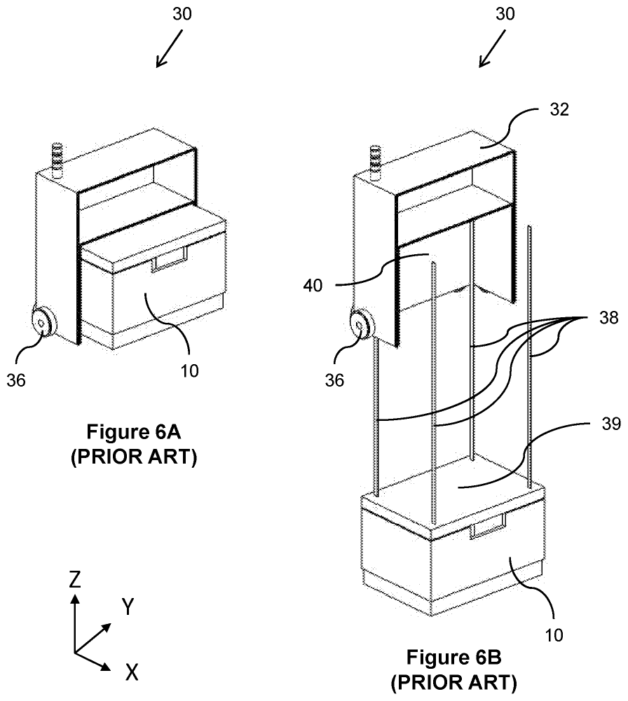

A known form of load-handling device 30—shown in FIGS. 5, 6A and 6B—is described in PCT Patent Publication No. WO2015/019055 (Ocado Innovations Limited) and corresponding U.S. Pat. No. 10,000,337 (Ocado Innovations Limited), the entire content of which is incorporated herein by reference, where each load-handling device 30 covers a single grid space 17 of the grid framework structure 14. This arrangement allows a higher density of load handlers and thus a higher throughput for a given sized system.

The load-handling device 30 comprises a vehicle 32, which is arranged to travel on the rails 22 of the frame structure 14. A first set of wheels 34, consisting of a pair of wheels 34 on the front of the vehicle 32 and a pair of wheels 34 on the back of the vehicle 32, is arranged to engage with two adjacent rails of the first set 22a of rails 22. Similarly, a second set of wheels 36, consisting of a pair of wheels 36 on each side of the vehicle 32, is arranged to engage with two adjacent rails of the second set 22b of rails 22. Each set of wheels 34, 36 can be lifted and lowered, by way of a direction-change assembly, so that either the first set of wheels 34 or the second set of wheels 36 is engaged with the respective set of rails 22a, 22b at any one time. For example, when the first set of wheels 34 is engaged with the first set of rails 22a and the second set of wheels 36 is lifted clear from the rails 22, the first set of wheels 34 can be driven, by way of a drive assembly, housed in the vehicle 32, to move the load-handling device 30 in the X-direction. To achieve movement in the Y-direction, the first set of wheels 34 is lifted clear of the rails 22, and the second set of wheels 36 is lowered into engagement with the second set 22b of rails 22. The drive assembly can then be used to drive the second set of wheels 36 to move the load-handling device 30 in the Y direction.

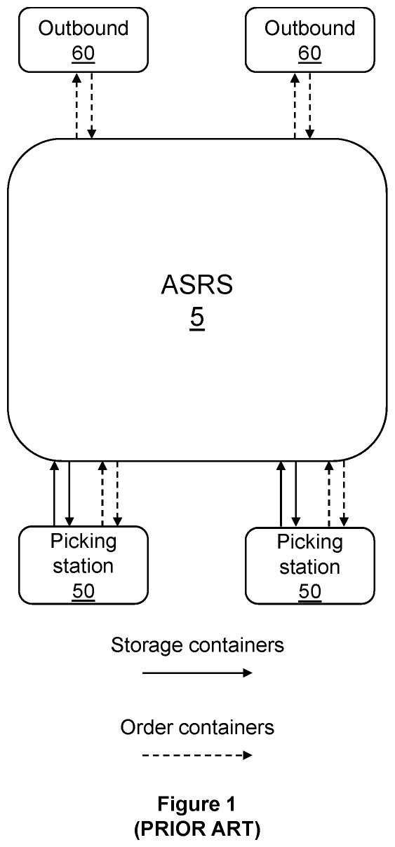

The load-handling device 30 is equipped with a container-lifting device or assembly, e.g. a crane mechanism, to lift a storage container from above. The lifting device comprises a winch tether or cable 38 wound on a spool or reel and a gripper device 39. The lifting device shown in FIG. 4 comprises a set of four lifting tethers 38 extending in a vertical direction. The tethers 38 are connected at or near the respective four corners of the gripper device 39, e.g. a lifting frame, for releasable connection to a storage container 10. For example, a respective tether 38 is arranged at or near each of the four corners of the lifting frame. The gripper device 39 is configured to releasably grip the top of a storage container 10 to lift it from a stack of containers in a storage system of the type shown in FIGS. 1 and 2. For example, the lifting frame 39 may include pins (not shown) that mate with corresponding holes (not shown) in the rim that forms the top surface of bin 10, and sliding clips (not shown) that are engageable with the rim to grip the bin 10. The clips are driven to engage with the bin 10 by a suitable drive mechanism housed within the lifting frame 39, powered and controlled by signals carried through the cables 38 themselves or a separate control cable (not shown).

To remove a bin 10 from the top of a stack 12, the load-handling device 30 is first moved in the X-and Y-directions to position the gripper device 39 above the stack 12. The gripper device 39 is then lowered vertically in the Z-direction to engage with the bin 10 on the top of the stack 12, as shown in FIGS. 5 and 6B. The gripper device 39 grips the bin 10, and is then pulled upwards by the cables 38, with the bin 10 attached. At the top of its vertical travel, the bin 10 is held above the rails 22 accommodated within the vehicle body 32. In this way, the load-handling device 30 can be moved to a different position in the X-Y plane, carrying the bin 10 along with it, to transport the bin 10 to another location. On reaching the target location (e.g. another stack 12, an access point in the storage system, a picking station 50, an outbound area 60, or a conveyor belt) the bin or container 10 can be lowered from the container receiving portion and released from the grabber device 39. The cables 38 are long enough to allow the load-handling device 30 to retrieve and place bins from any level of a stack 12, e.g. including the floor level.

As shown in FIG. 4, a plurality of identical load-handling devices 30 is provided so that each load-handling device 30 can operate simultaneously to increase the system's throughput. The system illustrated in FIG. 3 may include specific locations, known as ports, at which bins 10 can be transferred into or out of the system. An additional conveyor system (not shown) may be associated with each port so that bins 10 transported to a port by a load-handling device 30 can be transferred to another location by the conveyor system, such as a picking station (not shown) or outbound station (not shown). Alternatively, the ports may connect directly to the picking station or outbound station. Similarly, bins 10 can be moved by the conveyor system to a port from an external location, for example, to a bin-filling station (not shown), and transported to a stack 12 by the load-handling devices 30 to replenish the stock in the system. Alternatively to using a port to access a picking station, a robotic arm may be disposed above the containers and adapted to be operable on or above the rails or tracks 22a, b, as disclosed in International Patent Application Publication No. WO2017081281A1 and corresponding U.S. Pat. No. 10,899,539, the entire content of which is incorporated herein by reference. The robotic arm is adapted to pick at least one item from a storage containers and deposit the at least one item in an order container.

Each load-handling device 30 can lift and move one bin 10 at a time. The load-handling device 30 has a container-receiving cavity or recess 40, in its lower part. The recess 40 is sized to accommodate the container 10 when lifted by the lifting mechanism, as shown in FIGS. 6A and 6B. When in the recess, the container 10 is lifted clear of the rails 22 beneath, so that the vehicle 32 can move laterally to a different grid location.

If it is necessary to retrieve a bin 10b (“target bin”) that is not located on the top of a stack 12, then the overlying bins 10a (“non-target bins”) must first be moved to allow access to the target bin 10b. This is achieved by an operation referred to hereafter as “digging”. Referring to FIG. 4, during a digging operation, one of the load-handling devices 30 lifts each non-target bin 10a sequentially from the stack 12 containing the target bin 10b and places it in a vacant position within another stack 12. The target bin 10b can then be accessed by the load-handling device 30 and moved to a port for further transportation.

### Control of ASRS

Each of the provided load-handling devices 30 is remotely operable under the control of a central computer. Each individual bin 10 in the system is also tracked so that the appropriate bins 10 can be retrieved, transported, and replaced as necessary. For example, during a digging operation, each non-target bin location is logged so that the non-target bin 10a can be tracked.

Wireless communications and networks may be used to provide the communication infrastructure from a master controller, e.g. via one or more base stations, to one or more load-handling devices operative on the grid structure. In response to receiving instructions from the central computer, a controller in the load-handling device is configured to control various driving mechanisms to control the movement of the load-handling device. For example, the load-handling device may be instructed to retrieve a container from a target storage column at a particular location on the grid structure. The instruction can include various movements in the X-Y plane of the grid structure 15. As previously described, once at the target storage column, the lifting mechanism can be operated to grip and lift the storage container 10. Once the container 10 is accommodated in the container-receiving space 40 of the load-handling device 30, it is subsequently transported to another location on the grid structure 15, e.g. a “drop-off port”. At the drop-off port, the container 10 is lowered to a suitable pick station to allow retrieval of any item in the storage container. Movement of the load-handling devices 30 on the grid structure 15 can also involve the load-handling devices 30 being instructed to move to an outbound area, usually located at the periphery of the grid structure 15.

To manoeuvre the load-handling devices 30 on the grid structure 15, each of the load-handling devices 30 is equipped with motors for driving the wheels 34, 36.

Although each load-handling device can be controlled individually, this is part of a collective control scheme/algorithm that co-ordinates the load-handling devices to move containers and provide instructions to picking stations, such as control instructions for a robotic arm or a display on a user interface for a human picker, either of which results in the desired item being transferred from a storage container to an order container.

International Patent Application Publication No. WO2015185628 and corresponding U.S. Pat. No. 10,086,999, the entire content of which is incorporated herein by reference, discloses a system and method for collectively controlling the load-handling devices to move containers to and/or from: storage locations in the grid storage structure, and/or pick stations 50, and/or inbound stations (i.e. those used to provide storage containers with products/items and/or empty storage containers), and/or outbound areas 60. The load-handling devices can also be configured to avoid and re-route around certain areas, as disclosed in WO2019138392. The load-handling devices can also be controlled to move or shunt load-handling devices that are stationary on a planned path of another load-handling device, as disclosed in International Patent Application Publication No. WO2022013365 and corresponding US Patent Application Publication No. US2023/0264897, the entire content of which is incorporated herein by reference. This way, a stationary or idle load-handling device does not obstruct a planned movement of another load-handling device.

From International Patent Application Publication Nos. WO2015185628, WO2019138392, and WO2022013365, the skilled person will appreciate that the actions of the load-handling devices may be pre-planned on the basis of advanced customer orders.

Typically, the containers necessary for a pre-planned task arrive just-in-time to complete that pre-planned task. For example, a storage container with an item/product for a customer order will arrive at a picking station at the same time as an order container, and thus minimise the time to transfer that item/product from the storage container to the order container. As another example, a group of pick stations in close proximity may be responsible for completing a batch of customer orders that will be delivered together (e.g. all customer orders in a delivery vehicle). This means the containers can be filled by moving order containers short distances between the pick stations of the group of pick stations. Further, once the order containers have been filled, they can be moved within the same time window to an outbound region. This in turn minimises the time required to load the delivery vehicle since all order containers for that vehicle are ready to be loaded. Further, the picking tasks of a current batch of customer orders can be underway as the previous batch of customer orders are moved to or arrive at or exit via the outbound area.

To plan a specific path/route for each load-handling device on the tracks 22a,b, a branch and bound function can be used, where a cost function based on time taken and heat (i.e. load-handling device congestion) for a given route is used to select the optimal route (i.e. the route that minimises the cost function). Every planned route can be reserved in advance, but still require clearance to proceed along the route.

The movement of the containers within the grid storage structure, to and/or from a picking station and/or an outbound area is planned/co-ordinated such that a given container arrives ‘just-in-time’ for a pre-planned task (such as picking or outbound). The pre-planned tasks are grouped to process a batch of customer orders (i.e. containers destined for same delivery vehicle) as efficiently as possible whilst meeting the just-in-time criterion. Efficiency in this sense is to reduce the overall movements required by the load-handling devices to fulfil a batch of customer orders. Movements include the X, Y, and Z-movements, the total of which should be minimised. X and Y movements are those along the tracks 22a,b and Z movements are those required to access particular containers at selected depths of a stack.

However, trade-offs may be required to ensure that the just-in-time criterion is met. For example, it may not be efficient for a load-handling device to travel to the farthest located picking station, but if that is the only operational/active picking station, the load-handling device should nonetheless proceed to meet the just-in-time criterion. Although waiting for a closer picking station to be available is an option, the time waiting could result in a filled container not meeting the just-in-time criterion at the outload area for a batch of orders. Accordingly, the batch of orders may be delayed. Similar considerations apply in respect of choosing which outload area to which the load-handling device should travel with a filled container for a batch of customer orders.

From International Patent Application Publication Nos. WO2015185628, WO2019138392, and WO2022013365, the skilled person will appreciate that the control of the load-handling device to fulfil a customer order is similar in principle to an air traffic control system, where individual flights are pre-planned as efficiently as possible, reserved and cleared, then updated in real-time during the flights, to arrive just-in-time at a given runway.

In general, the movement of the containers within the grid storage structure, to and/or from a picking station and/or an outbound area is planned/co-ordinated such that a given container arrives ‘just-in-time’ for a pre-planned task (such as picking or outbound) of a group of pre-planned tasks necessary to fulfil a customer order or batch of customer orders, using the minimum number of load-handling device movements in the X, Y, and Z directions. Put another way, individual and collective movement of the load-handling devices is based on balancing a just-in-time criterion for respective pre-planned tasks necessary to fulfil a respective customer order with the time taken to move containers to and from the gird storage structure, picking stations, or outload stations. This also requires consideration of the load-handling devices themselves such as battery charge level, acceleration profile, or deceleration profile.

Thus, both the locations and status of the storage containers, order containers, picking stations, and outload areas are taken into account. Status in this respect means whether the storage and/or order containers are empty, partially filled, or filled, and whether a picking station and/or outload area is operational/active/available. Achieving the correct balance means that the load-handling devices are constantly moving/operating. Failure to balance means load-handling devices may remain idle such as waiting for a pick station, which may have fallen behind schedule, to become available.

### Dynamic Resource Allocation

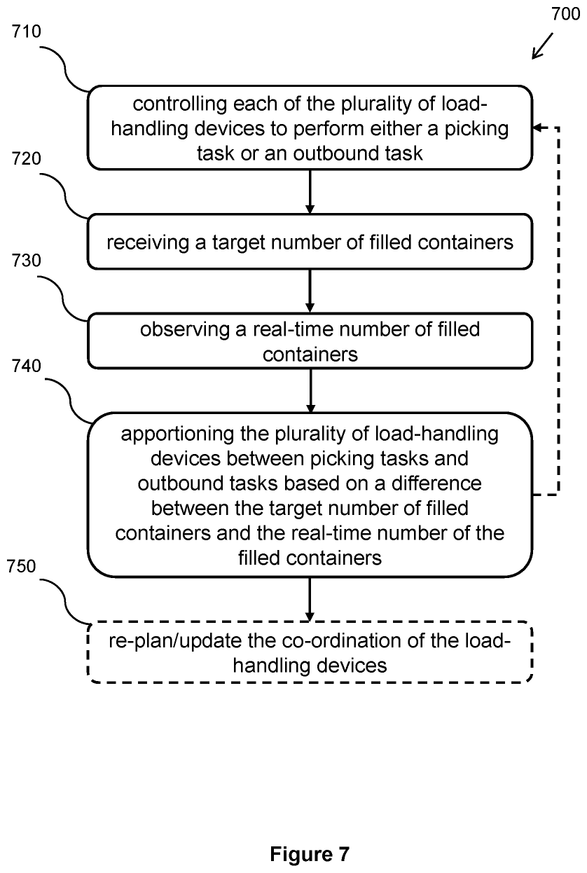

With reference to FIG. 7, a method 700 according to the invention is described. In step 710, a plurality of load-handling devices are controlled to perform either a picking task or an outbound task. The plurality of load-handling may be a fixed number depending on the customer orders, and the specific configuration of the ASRS.

Based on the number of customer orders, a target number of filled containers (i.e. those ready for outbound) may be determined at step 720. The target number of containers may be based on historic monthly, weekly, or daily averages, and can correspond to a rate. For example, a target number may be the number of filled containers over x minutes, where x is set accordingly. The target number may not be fixed, and be updated periodically. At step 730, the real-time number of filled containers is determined. The real-time number is comparable to the target number, e.g. the actual number of containers filled over the same x minutes as the target number is determined. As mentioned above, the status of all containers in the ASRS is logged so the number of filled containers is readily available.

At step 740, based on the difference between the target number of filled containers and the real-time number of filled containers, an apportionment of load-handling devices between picking and outbound tasks is determined. At optional step 750, the coordination of the load-handling devices is re-planned/updated at the same time as the apportionment to take into account the current number of load-handling devices available for a respective task. Put another way, the future planning/routing for the load-handling devices takes into account the determined apportionment of load-handling devices for picking and outbound tasks, as determined from step 740. Prior to the future planning/routing taking effect, the load-handling devices complete any existing tasks that may be underway and/or that was already planned before the load-handling devices are reassigned to new tasks as per the most recent assignment/allocation/apportionment of load-handling devices. Accordingly, plans/routes may be generated every x minutes to correspond to the most recent assignment/allocation/apportionment of load-handling devices. As shown in FIG. 7, the method may be iterative in line with the rate at which the target number and/or filled number of containers is determined. Further, the target number of containers may be dynamically varied, say in response to a rate at which customer orders are received.

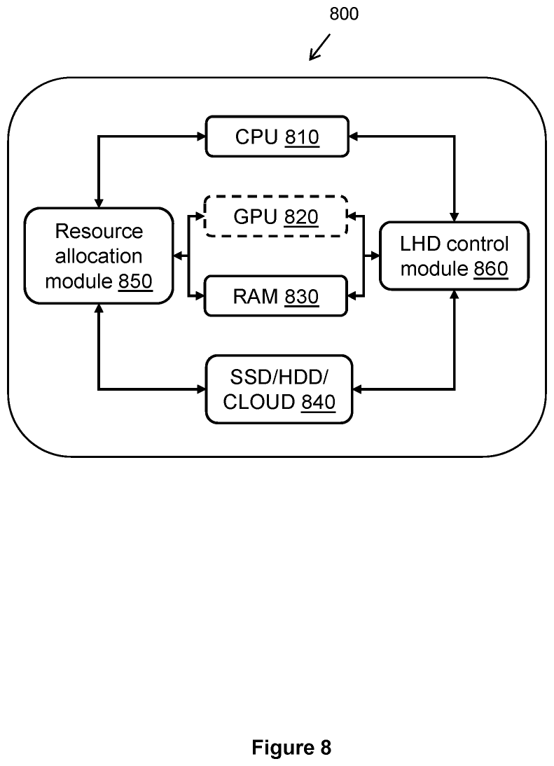

A system 800 (which could be the central computer or master controller referenced above) for carrying out the method of FIG. 7 is shown in FIG. 8. The central processing unit, CPU, 810, optional graphical processing unit, GPU 820, random access memory 830, and storage 840, which may be solid state drive, SDD, or hard disc drive, HDD, or a cloud computing platform, interface with resource allocation module 850 and load-handling device, LHD, control module 860. Resource allocation module is programmed to carry out the method of FIG. 7. LHD control module is programmed to effect the apportionment determined by the resource allocation module 850. LHD control module is also programmed to plan/co-ordinate the movements/routes of the load-handling devices such that a given container arrives ‘just-in-time’ for a pre-planned task (such as picking or outbound tasks) of a group of pre-planned tasks necessary to fulfil a customer order or batch of customer orders, using the minimum number of load-handling device movements. LHD control module may be configured to re-plan/update the co-ordination of the load-handling devices at the same time as the apportionment to take into account the current number of load-handling devices available for a respective task, as explained above in respect of step 750.

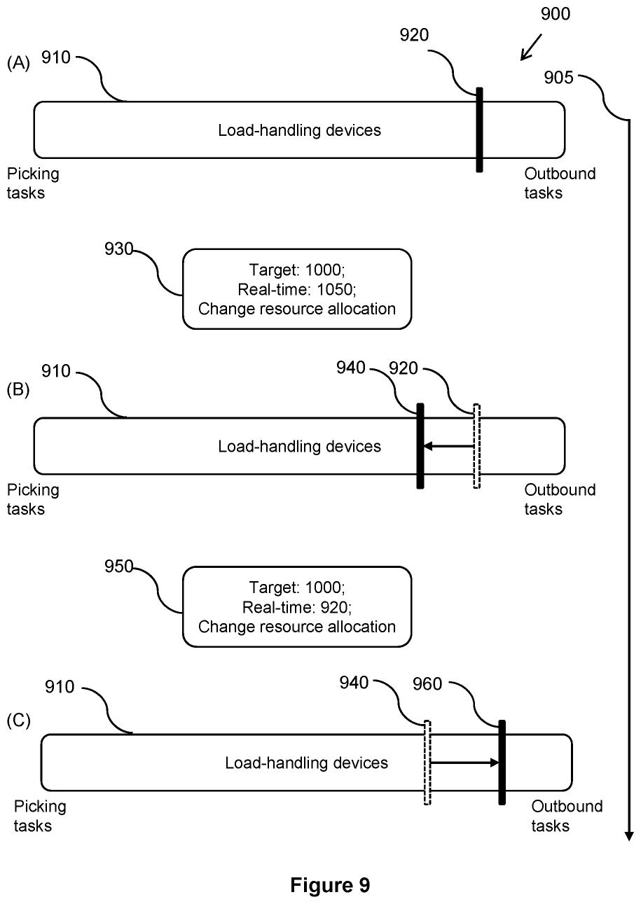

A conceptual representation of the application of the method of FIG. 7 is shown in FIG. 9, where 905 indicates a progression of time as the method of FIG. 7 is performed iteratively. In step (A) of FIG. 9, a number of load-handling devices, shown by 910, is apportioned, shown by 920, between picking tasks and outbound tasks.

Upon carrying out the method of FIG. 7, both the target number of filled containers and the real-time number of filled containers is determined, as shown in 930 between steps (A) and (B) of FIG. 9. From 930, it is determined that the resource allocation should change. In this case, the real-time number of filled containers is greater than the target number of filled containers, so the number of load-handling devices performing an outbound task is increased. The increase is shown in step (B) of FIG. 9 where the previous apportionment 920 of step (A) is changed to a new apportionment, denoted by 940.

After this increase is effected, another iteration of the method of FIG. 7 occurs and both the target number of filled containers and the real-time number of filled containers is determined, as shown in 950 between steps (B) and (C) of FIG. 9. From 950, it is determined that the resource allocation should change. In this case, the real-time number of filled containers is less than the target number of filled containers, so the number of load-handling devices performing a picking task is increased. The increase is shown in step (C) of FIG. 9 where the previous apportionment 940 of step (B) is changed to a new apportionment, denoted by 960.

In either case, the increase in the number of load-handling devices performing a respective outbound and picking task is proportional to the difference between the real-time number of filled containers and the target number of filled containers. Similarly, the decrease in the number of load-handling devices performing a respective picking and outbound task is proportional to the difference between the real-time number of filled containers and the target number of filled containers.

To determine the number of load-handling devices that should be reapportioned for a respective task (e.g. how many load-handling devices that were performing picking tasks that have been re-allocated to outbound tasks, or vice versa), a control function can be used.

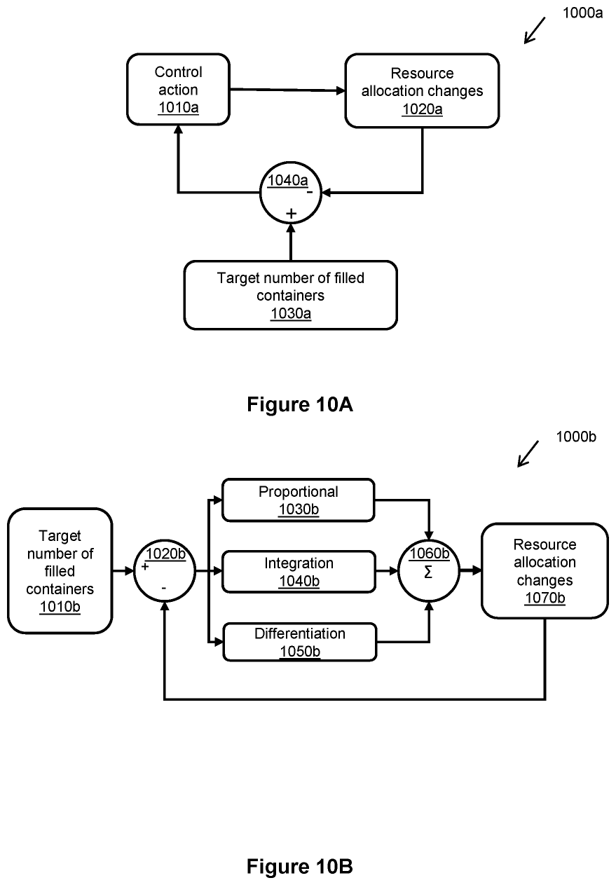

FIG. 10A shows a basic feedback loop 1000a that can be used to implement a control function. The control action 1010a determines that a change to the resource allocation (i.e. load-handling device allocation) is required based on an output from summing point 1040a. The output from the summing point is based on a difference between the between the real-time number of filled containers (determined by changes to resource allocation 1020a) and the target number of filled containers 1030a. The difference from the summing point is directly proportional to the resource allocation effected by the control action. That is, the number of load-handling devices that are reapportioned scales directly with the difference between the real-time number of filled containers and the target number of filled-containers. It will be appreciated that the exact scaling used can vary and will take into account the current configuration of the ASRS in terms of total number of grid spaces, overall layout, and locations of the pick stations and/or outbound areas.

FIG. 10B shows a proportional-integral-derivate, PID, controller 1000b that can be used to implement a control function. A summing point 1020b has an output based on a difference between the real-time number of filled containers (determined by changes to resource allocation 1070a). The output from the summing point 1020b is fed to parallel proportional 1030b, integration 1040b, and differentiation 1050b calculators, all of which are summed by summing point 1060b. The output of summing point 1060b sets how the resource allocation is changed in block 1070b. With the control function of FIG. 10b, the apportionment is thus a function (proportional, integral, and derivate) of the difference between the real-time number of filled containers and the target number of filled-containers. It will be appreciated that the exact function used can vary and will take into account the current configuration of the ASRS in terms of total number of grid spaces, overall layout, and locations of the pick stations and/or outbound areas.

### Modification of Dynamic Resource Allocation

The method of FIG. 7 can operate on the basis that there are a fixed number of operational/active pick stations and outbound areas. However, the status of pick stations and outbound areas may change with time. For example, pick stations may increase/decrease due to a number of reasons such as: whether a human picker is currently present; and/or whether a delivery vehicle is currently present to receive a batch of customer orders; and/or whether a systems failure has occurred at a pick station such as a stuck container, or picker user interface crash, or robotic picker arm malfunction etc. ; and/or a systems failure has occurred at an outbound area such as stuck container, conveyor belt failure etc. When the current throughput of a picking station and/or an outbound area is affected, perhaps due to one of the above reasons occurring, allocating further load-handling devices to a respective task could prove futile. For example, if the output of the method of FIG. 7 requires more load-handling devices to be assigned/allocated picking tasks, any such load-handling devices will form a queue (or queues) at the current active picking stations. In effect, there is insufficient picking station capacity to deal with the increased number of load-handling devices performing picking tasks. It will be appreciated that a similar situation can occur when there is insufficient outbound area capacity to deal with the increased number of load-handling devices performing outbound tasks. It would be advantageous if the method of FIG. 7 can be adapted to account for any such capacity issues.

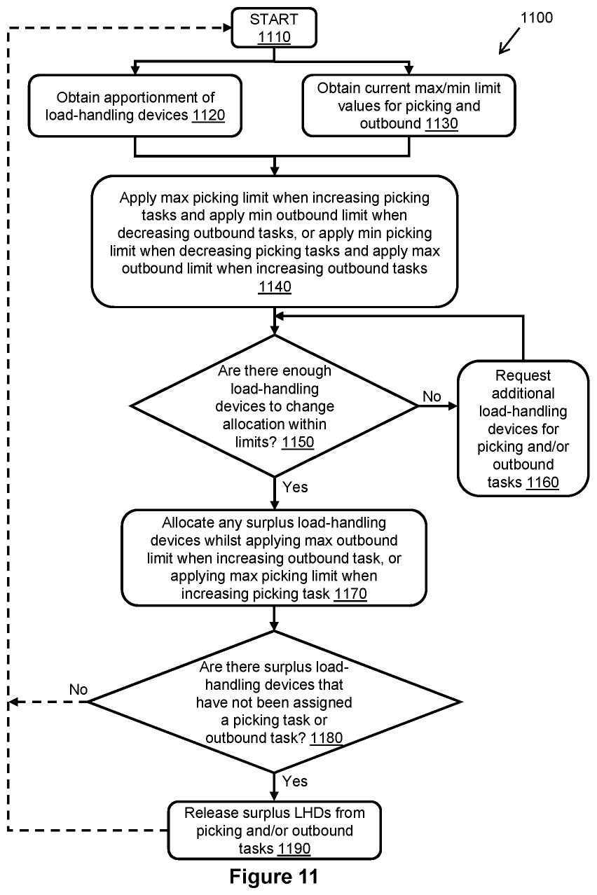

With reference to FIG. 11, a method is shown that can adapt for current capacity issues. The method of FIG. 11 can be performed using the system of FIG. 8, where the resource allocation module 850 is programmed accordingly. Upon the start 1110 of the method, both the apportionment 1120 (determined using the method of FIG. 7) and the current maximum and minimum capacity or limits or caps for picking stations and outbound areas is obtained. Capacity is defined by the number of load-handling devices that can be accommodated by picking stations or outbound areas respectively. Maximum capacity corresponds to when picking stations or outbound areas respectively are operating as efficiently as possible. For example, 40 operational picking stations may have human picker or robotic arms carrying out subsequent picking operation with minimum time between picks. Similarly, minimum capacity corresponds to when picking stations or outbound areas respectively are operating with reduced efficiency. For example, 20 operational picking stations may have human picker or robotic arms carrying out subsequent picking operations with increased time between picks. Although the human pickers or robotic arms have a reduced workload, the workload is nonetheless sufficient to maintain/justify the active number of pick stations.

Assuming the output of 1120 is an instruction to increase the number of load-handling devices assigned/allocated to picking tasks (and thus reduce the number of load-handling devices assigned/allocated to outbound tasks), the extent to which the number of load-handling devices increase and decrease is capped by the maximum capacity for picking tasks and minimum capacity for outbound tasks respectively. Conversely, assuming the output of 1120 is an instruction to increase the number of load-handling devices assigned/allocated to outbound tasks (and thus reduce the number of load-handling devices assigned/allocated to picking tasks), the extent to which the number of load-handling devices increase and decrease is capped by the maximum capacity for outbound tasks and minimum capacity for picking tasks respectively. Step 1140 thus allocates the picking and outbound tasks within the respective picking and outbound minimum/maximum limits.

Step 1150 checks whether the allocation determined by step 1140 is in fact possible. That is, there is a check whether the current number of total load-handling devices that performs either a picking or outbound task is sufficient to carry out the allocation/assignment determined by step 1140. For example, there may not be enough load-handling devices to increase the number of load-handling devices allocated/assigned for picking tasks as determined by step 1120 (within the maximum limit) and meet the minimum limit for the number of load handling devices for outbound tasks. In such an instance, step 1160 will request additional load-handling devices for picking and/or outbound tasks. Such load-handling devices can be ones that are idle or on standby within the ASRS. Step 1150 is re-run to see if the allocation is possible whilst meeting the relevant minimum limit. Assuming step 1150 can be answered yes, this ensures that either of the picking stations or outbound areas run at an acceptable level of efficiency. In other words, the number of currently open/active pick stations and/or outbound areas have a constant workload.

The method then proceeds to step 1170 where any surplus load-handling devices beyond a maximum limit of one task are allocated to the other task. For example, assuming the allocation determined by step 1120 increases the number of load-handling devices assigned/allocated to picking tasks up to the maximum limit, any remaining load-handling device are assigned/allocated to outbound tasks up to the maximum limit. Conversely, assuming the allocation determined by step 1120 increases the number of load-handling devices assigned/allocated to outbound tasks up to the maximum limit, any remaining load-handling device are assigned/allocated to picking tasks up to the maximum limit. This ensures that all load-handling devices designated for picking or outbound tasks are in fact allocated and thus maximise efficiency of both picking stations and outbound areas.

Step 1180 checks whether there are any surplus load-handling devices that have not been allocated/assigned to either a picking task or outbound task within respective maximum limits. If not, the method reverts to step 1110 for a further optional iteration of the method of FIG. 11. If so, the method proceeds to step 1190, where load-handling devices, LHDs, are released from picking and/or outbound tasks. This means that the total number of load-handling devices designated for either picking and/or outbound tasks is proportionate to the current throughput of filled containers. The method then can revert to step 1110 for a further optional iteration of the method of FIG. 11. Upon a load-handling device being released, it can then be designated for another task such as an inbound task where replenished containers enter the grid storage structure.

It will be appreciated that the method of FIG. 11 can be used to iteratively change both the total number of load-handling devices and apportionment thereof to maximise efficiency. In effect, the number of load-handling devices currently assigned for either a picking or outbound task is continually evaluated and updated to reflect the current filled container throughput and the status of the picking stations and outbound areas.

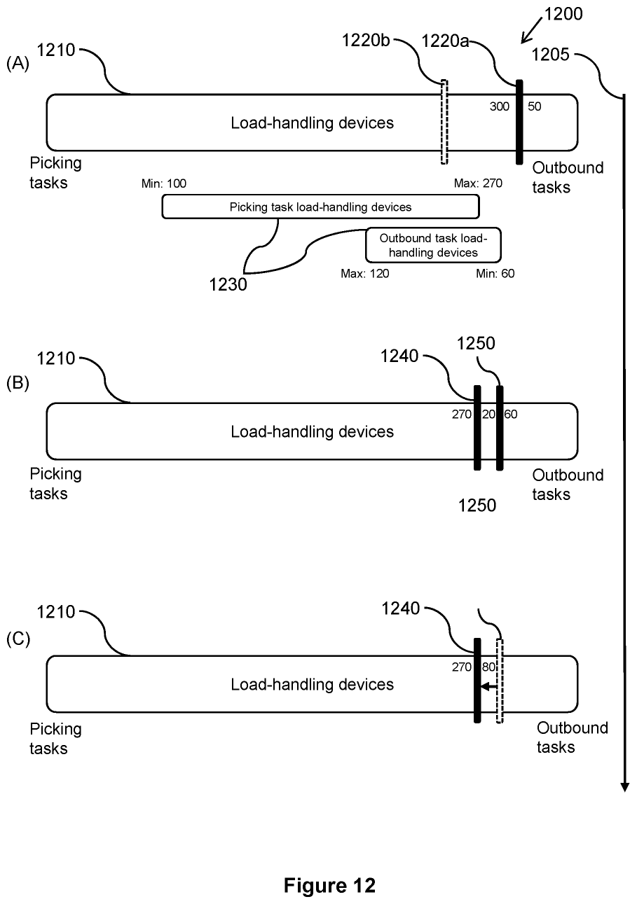

A first conceptual representation of the application of the method of FIG. 11 is shown in FIG. 12 where 1205 indicates a progression of time as the method of FIG. 11 is performed. In step (A) of FIG. 12, a number of load-handling devices, shown by 1210, is apportioned, shown by 1220a, between picking tasks and outbound tasks. The apportionment is determined by step 1120 of FIG. 11 to be 300 and 50 load-handling devices assigned to picking tasks and outbound tasks respectively. This represents a change from the previous allocation 1220b where the number of load-handling devices for picking and outbound tasks is now set to increase and decrease respectively. Also in step (A) of FIG. 12, the current minimum and maximum load-handling devices that can be assigned/allocated, as shown by 1230, to picking and outbound tasks is determined by step 1130 of FIG. 11. As shown in this example, the minimum and maximum limits for picking tasks are 100 and 270 respectively, whereas the minimum and maximum limits for outbound tasks are 60 and 120 respectively.

Step (B) of FIG. 12 shows that there are enough load-handling devices to apply both the maximum limit for picking tasks and the minimum limit for outbound tasks. As shown by step (B), there are 270 and 60 load-handling devices allocated to picking and outbound tasks respectively, represented by 1240 and 1250 respectively. Step 1170 of FIG. 11 can then occur, given that there are 20 surplus load-handling devices, as shown by step (B).

Step (C) of FIG. 12 shows that the twenty (i20) surplus load-handling devices are allocated to outbound tasks giving 270 and 80 load-handling devices allocated to picking and outbound tasks respectively, as shown by 1240. There are no surplus load-handling devices unassigned so step 1180 returns to the start 1110. Whilst this example dealt with the situation of increasing and decreasing the number of load-handling devices for picking and outbound tasks respectively, the reverse scenario of increasing and decreasing the number of load-handling devices for outbound and picking tasks respectively would operate in an equivalent way.

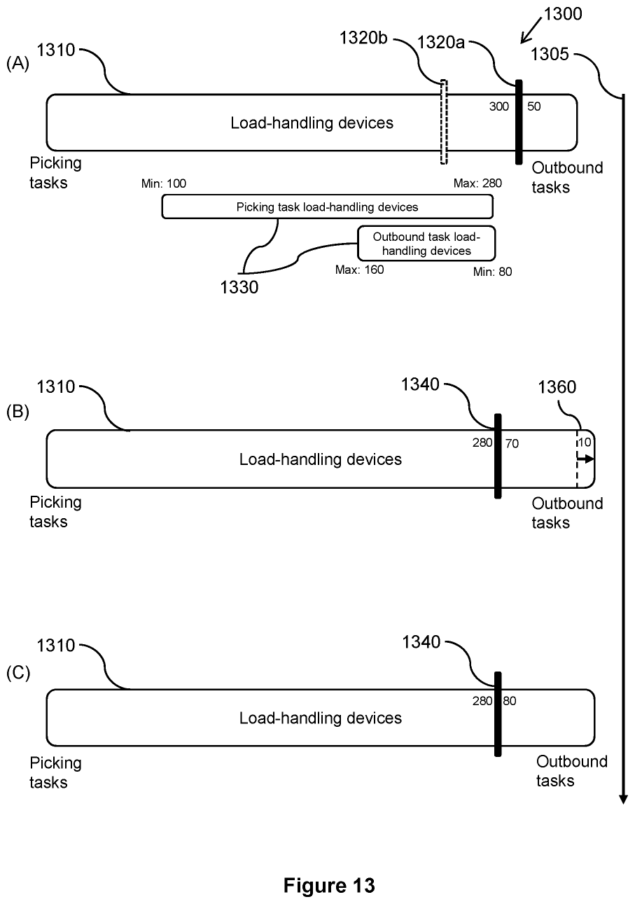

A second conceptual representation of the application of the method of FIG. 11 is shown in FIG. 13 where 1305 indicates a progression of time as the method of FIG. 11 is performed. In step (A) of FIG. 13, a number of load-handling devices, shown by 1310, is apportioned, shown by 1320a, between picking tasks and outbound tasks. The apportionment is determined by step 1120 of FIG. 11 to be 300 and 50 load-handling devices assigned to picking tasks and outbound tasks respectively. This represents a change from the previous allocation 1320b where the number of load-handling devices for picking and outbound tasks is now set to increase and decrease respectively. Also in step (A) of FIG. 13, the current minimum and maximum load-handling devices that can be assigned/allocated, as shown by 1330, to picking and outbound tasks is determined by step 1130 of FIG. 11. As shown in this example, the minimum and maximum limits for picking tasks are 100 and 280 respectively, whereas the minimum and maximum limits for outbound tasks are 80 and 160 respectively.

Step (B) of FIG. 13 shows that there are only enough load-handling devices to apply both the maximum limit for picking tasks and the minimum limit for outbound tasks, after an additional 10 load-handling devices are requested, as shown by 1360. Absent such a request, there would only be 70 load-handling devices allocated to outbound task which is below the minimum limit value of 80. As shown by step (B), there are 280 and 80 load-handling devices allocated to picking and outbound tasks respectively, represented by 1340 and 1350 respectively. The 80 load-handling devices allocated to outbound tasks includes 10 newly requested load-handling devices and 70 of the load-handling devices originally allocated to either a picking or outbound task. Therefore step 1120 of FIG. 11 was initially answered in the negative so step 1160 occurs resulting in 10 additional load-handling devices, as shown by 1360. After a further iteration of step 1150, steps 1170 and 1180 of FIG. 11 can then occur.

Step (C) of FIG. 13 shows that 0 surplus load-handling devices are allocated to outbound tasks giving 280 and 80 load-handling devices allocated to picking and outbound tasks respectively, as shown by 1340. There are no surplus load-handling devices unassigned so step 1180 returns to the start 1110. Whilst this example dealt with the situation of increasing and decreasing the number of load-handling devices for picking and outbound tasks respectively, the reverse scenario of increasing and decreasing the number of load-handling devices for outbound and picking tasks respectively would operate in the equivalent way.

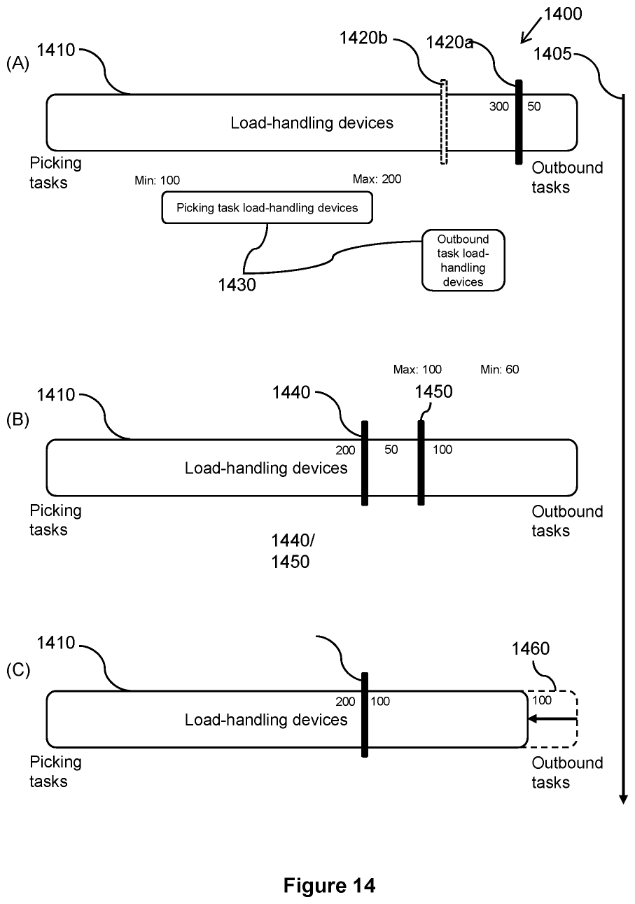

A third conceptual representation of the application of the method of FIG. 11 is shown in FIG. 14 where 1405 indicates a progression of time as the method of FIG. 11 is performed. In step (A) of FIG. 14, a number of load-handling devices, shown by 1410, is apportioned, shown by 1420a, between picking tasks and outbound tasks. The apportionment is determined by step 1120 of FIG. 11 to be 300 and 50 load-handling devices assigned to picking tasks and outbound tasks respectively. This represents a change from the previous allocation 1420b where the number of load-handling devices for picking and outbound tasks is now set to increase and decrease respectively. Also in step (A) of FIG. 14, the current minimum and maximum load-handling devices that can be assigned/allocated, as shown by 1430, to picking and outbound tasks is determined by step 1130 of FIG. 11. As shown in this example, the minimum and maximum limits for picking tasks are 100 and 200 respectively, whereas the minimum and maximum limits for outbound tasks are 60 and 100 respectively.

Step (B) of FIG. 13 shows that there are enough load-handling devices to apply both the maximum limit for picking tasks and the maximum limit for outbound tasks As shown by step (B), there are 200 and 100 load-handling devices allocated to picking and outbound tasks respectively, represented by 1440 and 1450 respectively. This is the outcome of having applied steps 1140, 1150, and 1170 of FIG. 11.

Step 1180 of FIG. 11 can then occur, given that there are 50 surplus load-handling devices, as shown by step (B). Step 1180 in this example is thus answered in the positive since. These surplus load-handling devices can be released from picking and/or outbound tasks as shown in step (C) of FIG. 14, as per step 1190 of FIG. 11. Whilst this example dealt with the situation of increasing and decreasing the number of load-handling devices for picking and outbound tasks respectively, the reverse scenario of increasing and decreasing the number of load-handling devices for outbound and picking tasks respectively would operate in the equivalent way.

The inventors have found that the above methods and systems can be used to maintain an ASRS filled container throughput whilst minimising the overall number of active load-handling devices used. Equivalently, a filled container throughout can be increased whilst sill using the same number of load-handling devices. In general, a number of load-handling devices used, and/or a number of grid spaces (a grid space denoting an area below which there is a single stack of containers accessible by a load-handling device on that grid space), and/or a number of picking stations, and/or a number of outbound areas scale up or down with a (predicted/anticipated) number of customer orders or orders over a period of time (e.g. 24 hours or 1 week). The skilled person will thus understand that the invention is readily scalable and will work over a range of operating conditions.

As one illustrative example, an ASRS with ~14,000 grid spaces, ~30 picking stations, and ~15 exit (or outload) areas is able to achieve ~100,000 orders or customer orders per week (which correlates to the number of filled containers) when 300 load-handling devices are used for both picking and outbound tasks, with a fixed apportionment. With the present invention, the ability to dynamically vary the apportionment meant that ~130,000 orders or customer orders per week was achieved using 300 load-handling devices. This corresponds to a 30% efficiency improvement.

The invention has been found to scale well and an ASRS with 10-50 grid spaces, 1 picking area, 1 outbound area, and 2 load-handling devices also sees efficiency improvements when using the invention.

As another example, an ASRS with ~9,000 grid spaces, ~6 picking stations, ~2 exit (or outload) stations, and 40-150 load-handling devices also sees efficiency improvements when using the invention.

As yet another example, an ASRS with ~3,500 grid spaces, ~5 picking stations, ~2 exit (or outload) stations, and 20-140 load-handling devices also sees efficiency improvements when using the invention.

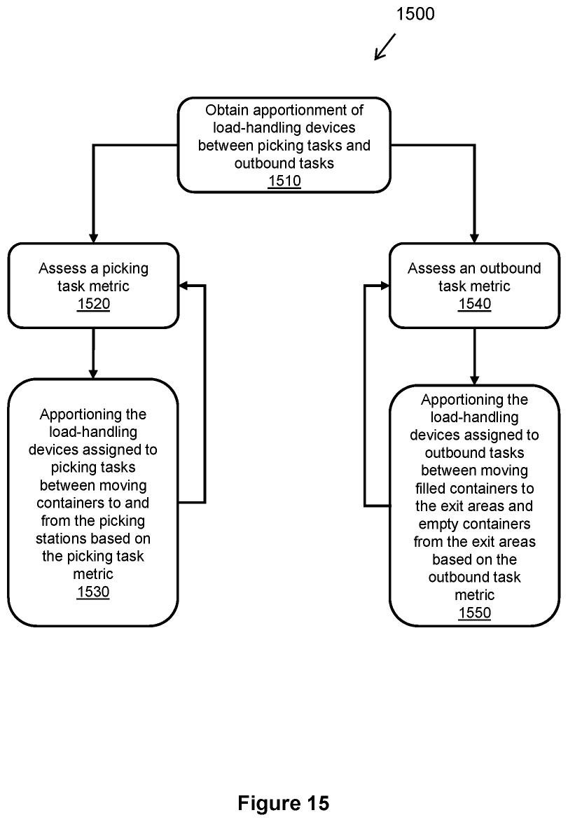

FIG. 15 shows a further method 1500 that can be applied in addition to the above methods of FIGS. 7 and 11, both of which result in an apportionment of load-handling devices between picking and outbound tasks. Alternatively, the method of FIG. 15 can be applied independently of the methods of FIGS. 7 and 11 by starting from a pre-determined fixed apportionment of load-handling devices between picking and outbound tasks.

In step 1510, an apportionment of load-handling devices between picking tasks and outbound tasks, is obtained. In step 1520, a picking task metric is assessed. In one example, the picking task metric may be a number of under-capacity picking stations and a number of over-capacity pick stations. Under-capacity may be when the transfer of items from a storage container to an order container is at a rate which means the pick station has sustained periods of inactivity. Conversely, over-capacity may be when the transfer of items from a storage container to an order container is at a rate which means the pick station has sustained periods of activity, and may include a backlog. In another example, the metric may be a rate at which containers are moved to the picking stations and a rate at which containers are moved from the picking stations.

In step 1530, the load-handling devices assigned to picking tasks are apportioned between moving containers to and from the picking stations based on the picking task metric.

In the first example above, if the number of under-capacity pick stations is greater than the number of over-capacity pick stations, the number of load-handling devices to move containers to the under-capacity pick stations can be increased (which decreases the number of load-handling devices moving containers to and/or from the over-capacity pick stations). Conversely, if the number of under-capacity pick stations is less than the number of over-capacity pick stations, the number of load-handling devices to move containers from the over-capacity pick stations can be increased (which decreases the number of load-handling devices moving containers to and/or from the under-capacity pick stations). The aim in the first example is to balance the number of under-capacity pick stations with the number of over-capacity pick stations.

In the second example above, if the rate at which containers are moved to the picking stations is greater than the rate at which containers are moved from the picking stations, the number of load-handling devices moving containers from the picking stations is increased (which decreases the number of load-handling moving containers to the picking stations). Conversely, if the rate at which containers are moved to the picking stations is less than the rate at which containers are moved from the picking stations, the number of load-handling devices moving containers to the picking stations is increased (which decreases the number of load-handling moving containers from the picking stations). The aim in the second example is to balance the rate at which containers are moved to the picking stations and the rate at which containers are moved from the picking stations. As shown by FIG. 15, steps 1520 and 1530 can be part of an iterative loop (e.g. periodic) to dynamically optimise the apportionment of load-handling devices assigned to picking tasks between moving containers to and from the picking stations based on the picking task metric.

In step 1540, an outbound task metric is assessed. In one example, the outbound task metric may be a number of under-capacity exit areas and a number of over-capacity exit areas. Under-capacity may be when the moving of filled containers to an exit area and/or moving of empty containers from the exit area is at a rate which means the exit area has sustained periods of inactivity. Conversely, over-capacity may be when the moving of filled containers to an exit area and/or moving of empty containers from the exit area is at a rate which means the pick station has sustained periods of activity, and may include a backlog. In another example, the metric may be a rate at which filled containers are moved to the exit areas and a rate at which empty containers are moved from the exit areas.

In step 1550, the load-handling devices assigned to outbound tasks are apportioned between moving filled containers to the exit areas and empty containers from the exit areas based on the outbound task metric.

In the first example above, if the number of under-capacity exit areas is greater than the number of over-capacity exit areas, the number of load-handling devices to move filled containers to the under-capacity exit areas can be increased (which decreases the number of load-handling devices moving filled containers to and/or empty containers from the over-capacity exit areas). Conversely, if the number of under-capacity exit areas is less than the number of over-capacity exit areas, the number of load-handling devices to move empty containers from the over-capacity pick stations can be increased (which decreases the number of load-handling devices moving filled containers to and/or empty containers from the under-capacity exit areas). The aim in the first example is to balance the number of under-capacity exit areas with the number of over-capacity exit areas.

In the second example above, if the rate at which filled containers are moved to the exit areas is greater than the rate at which empty containers are moved from the exit areas, the number of load-handling devices moving empty containers from the exit areas is increased (which decreases the number of load-handling moving filled containers to the exit areas). Conversely, if the rate at which containers are filled moved to the exit areas is less than the rate at which empty containers are moved from the exit areas, the number of load-handling devices moving filled containers to the exit areas is increased (which decreases the number of load-handling moving empty containers from the exit areas). The aim in the second example is to balance the rate at which filled containers are moved to the exit areas and the rate at which empty containers are moved from the exit areas. As shown by FIG. 15, steps 1540 and 1550 can be part of an iterative loop (e.g. periodic) to dynamically optimise the apportionment of load-handling between moving filled containers to the exit areas and empty containers from the exit areas based on the outbound task metric.

The method steps shown in FIG. 15 can further improve the efficiency of the ASRS.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention can take the form of an entirely hardware embodiment, an entirely software embodiment or an embodiment containing both hardware and software elements. In a preferred embodiment, the invention is implemented in software.

Furthermore, the invention can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments of the present invention. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

What is claimed is:

1. A computer-implemented method for controlling a system, the system comprising:
a first set of tracks extending in a first direction and a second set of tracks extending in a second direction which is transverse to the first direction, wherein the first and second sets of tracks are in a substantially horizontal plane to form a grid comprising a plurality of grid spaces to form a plurality of vertical storage locations beneath the grid for containers to be guided by uprights in a vertical direction through the plurality of grid spaces;
a plurality of load handling devices, wherein each load-handling device is configured to move along the first and/or second sets of tracks, and lift a container from beneath the grid and/or lower a container beneath the grid, the method comprising:
controlling each of the plurality of load handling devices to perform either a picking task or an outbound task, wherein a picking task comprises moving containers to and/or from a picking station to fill containers, each filled container comprising at least one predetermined item, wherein an outbound task comprises moving a filled container to an exit area of the system for the filled containers;
determining a target number of filled containers;
determining a real-time number of filled containers; and
apportioning the plurality of load-handling devices between picking tasks and outbound tasks based on a difference between the target number of filled containers and the real-time number of the filled containers.

2. The computer-implemented method of claim 1, wherein upon the real-time number of filled containers being greater than the target number of filled containers, increasing the number of load-handling devices performing an outbound task.

3. The computer-implemented method of claim 2, wherein the increase in the number of load-handling devices performing an outbound task is directly proportional to the difference between the real-time number of filled containers and the target number of filled containers.

4. The computer-implemented method of claim 2, wherein the increase in the number of load-handling devices performing an outbound task is a function of the difference between the real-time number of filled containers and the target number of filled containers.

5. The computer-implemented method of claim 1, wherein upon the real-time number of filled containers being less than the target number of filled containers, increasing the number of load-handling devices performing a picking task.

6. The computer-implemented method of claim 5, wherein the increase in the number of load-handling devices performing a picking task is directly proportional to the difference between the real-time number of filled containers and the target number of filled containers.

7. The computer-implemented method of claim 4, wherein the increase in the number of load-handling devices performing a picking task is a function of the difference between the real-time number of filled containers and the target number of filled containers.

8. The computer-implemented method of claim 1, wherein each picking station comprises an area to which and/or from which a load-handling device can move containers such that an item can be transferred from a storage container to an order container.

9. The computer-implemented method of claim 8, wherein each pick station comprises a robotic arm to transfer an item from a storage container to an order container, and optionally wherein the robotic arm is disposed above the containers and adapted to be operable on or above the first and/or second sets of tracks.

10. The computer-implemented method of claim 1, wherein each exit area comprises an area to which a load-handling device can move a filled container and/or from which a load-handling device can move an empty container.

11. The computer-implemented method of claim 1, wherein the real-time number of filled containers is observed periodically to define a rate.

12. The computer-implemented method of claim 1, wherein the target number of filled containers is a target rate of filled containers.

13. The computer-implemented method of claim 1, wherein a number of load-handling devices that is apportioned between picking and outbound tasks is fixed.

14. The computer-implemented method of claim 1, wherein the number of load-handling devices performing a picking task is constrained by respective minimum and maximum limits, and the number of load-handling devices performing an outbound task is constrained by respective minimum and maximum limits.

15. The computer-implemented method of claim 14, wherein the method further comprises requesting additional load handling devices to ensure that at least one of respective minimum limit of either the picking tasks or outbound tasks, is met.

16. The computer-implemented method of claim 14, wherein any surplus load-handling devices beyond the respective maximum limit of the number of load-handling devices performing one of a picking task or an outbound task are assigned to the other of the picking task or outbound task up to a respective maximum limit.

17. The computer-implemented method of claim 15, wherein any surplus load-handling devices beyond the respective maximum limits of the number of load-handling devices performing a picking task and an outbound task are released from performing either a picking task or an outbound task.

18. The computer-implemented method of claim 1, wherein the load-handling devices are controlled to move containers such that a given container arrives just-in-time for respective picking and/or outbound tasks to fulfil a respective customer order whilst using as few as load-handling device movements as possible.

19. The computer-implemented method of claim 1, wherein the method is performed periodically to apportion the plurality of load-handling devices between picking tasks and outbound tasks every x minutes.

20. The computer-implemented method of claim 19, wherein routes of the plurality of load-handling devices are re-planned every x minutes.
